(19) United States
(12) Patent Application Publication
(10) Pub. No.: US 2009/0173286 A1
(43) Pub. Date: Jul. 9, 2009

(54) Animal dryer apparatus

(76) Inventors: Kimba M. Schetlin, Myrtle Beach, SC (US); Raymond M. Schetlin, Myrtle Beach, SC (US)

Correspondence Address: P. Jeff Martin of The McGougan Law Firm, LLC, 1180 Hwy. 17 N., Suite 2, P.O. Box 250, Little River, SC, 29566, US

(21) Appl. No.: 12/006,863

(22) Filed: Jan. 7, 2008

(51) Int. Cl. A01K 13/00

(52) U.S. Cl. 119/606

(57) ABSTRACT

An animal dryer apparatus is disclosed which includes an air chamber defined by a base subjacent to a platform, the air chamber enclosed by at least one wall formed along the perimeter of the base and the platform; means for generating and forcing heated air through the air chamber; the platform defining a plurality of apertures through which heated air is forced into fluid communication with an animal placed on the platform; an enclosure defining at least one wall upstanding from the platform; and an elevated feeding reservoir integral to the apparatus.

### RELATED APPLICATIONS

There are no previously filed, nor currently any co-pending applications, anywhere in the world.

### BACKGROUND OF THE INVENTION

1. Field of the Invention

This application discloses claims and embodiments generally related to an animal dryer apparatus, and, more particularly, to an improved animal dryer apparatus having an integral elevated feeding reservoir and a leash or tether latch.

2. Description of the Related Art

It is desirable for animal groomers and/or pet owners to have access to an apparatus that effectively dries the animal after becoming wet, including drying the animal's body fur, ears, paws and other areas. In drying the animal, the animal groomer or pet owner may prevent several issues, including tracking of water and debris in a business or home, while also avoiding the malodorous scents generated by wet animals, especially when the wet animal is allowed to air dry. Thus, it is advantageous to eliminate or avoid this and other issues if possible.

Several products and inventions have been proposed in order to achieve this goal. Several devices and apparatuses provide enclosures interconnected with a heat source so that an animal positioned within the enclosure is dried via heated air forced into the enclosure. However, the art does not appear to disclose the combination of features disclosed herein.

Accordingly, a need has arisen for an animal dryer apparatus having an integral elevated feeding reservoir and a leash or tether latch. The development of the animal dryer apparatus fulfills this need.

A search of the prior art did not disclose any patents that read directly on the claims of the instant invention; however, the following references were considered related.

U.S. Pat. No. 5,025,572, issued in the name of Cordier,

U.S. Pat. No. 3,286,370, issued in the name of Hope;

U.S. Pat. No. 4,314,410, issued in the name of Nichols;

U.S. Pat. No. 6,425,347 B1, issued in the name of Bogner et al.;

U.S. Pat. No. 6,826,850 B2, issued in the name of Jewell;

U.S. Pat. No. 2,881,733, issued in the name of Young, Jr. et al.;

U.S. Pat. No. 3,175,534, issued in the name of Pollard;

U.S. Pat. No. 3,985,102, issued in the name of Yonezawa;

U.S. Pat. No. 4,183,323, issued in the name of Maines; and

U.S. Pat. No. 4,559,903, issued in the name of Bloom et al.

Consequently, a need has been felt for an improved animal dryer apparatus having an integral elevated feeding reservoir and a leash or tether latch. This application presents claims and embodiments that fulfill a need or needs not yet satisfied by the products and inventions previously or presently available. In particular, the claims and embodiments disclosed herein describe a pet dryer apparatus providing unanticipated and nonobvious combination of features distinguished from the products and inventions preexisting in the art. The applicant is unaware of any product, disclosure or reference that discloses the features of the claims and embodiments disclosed herein.

### SUMMARY OF THE INVENTION

Therefore, it is an object of the present invention to provide an animal dryer apparatus.

It is another object of the present invention to provide an animal dryer apparatus comprising an air chamber defined by a base subjacent to a platform.

It is another object of the present invention to provide an air chamber enclosed by at least one wall formed along the perimeter of the base and the platform.

It is another object of the present invention to provide an animal dryer apparatus which includes an enclosure comprising at least one wall upstanding from the platform.

It is another object of the present invention to provide a means for generating heated air through the air chamber.

It is another object of the present invention to provide an animal dryer apparatus which includes a means for securing an animal's tether.

It is still another object of the present invention to provide an animal dryer apparatus which includes at least one feeding reservoir integral to the apparatus.

It is yet another object of the present invention to provide an animal dryer apparatus which includes at least one horizontally and/or vertically adjustable feeding reservoir suitably mounted to the apparatus.

In accordance with one embodiment of the present invention, an animal dryer apparatus is disclosed, the apparatus comprising an air chamber defined by a base subjacent to a platform, the air chamber enclosed by at least one wall formed along the perimeter of the base and the platform; means for generating and forcing heated air through the air chamber; the platform comprising a plurality of apertures through which heated air is forced into fluid communication with an animal placed on the platform; an enclosure comprising at least one wall upstanding from the platform; and an elevated feeding reservoir integral to the apparatus.

In accordance with another embodiment, an animal dryer apparatus is disclosed, the apparatus comprising: an air chamber defined by a base subjacent to a platform, the air chamber enclosed by at least one wall formed along the perimeter of the base and the platform; means for generating heated air through the air chamber; the platform comprising a plurality of apertures through which heated air is forced into fluid communication with an animal placed on the platform; an enclosure comprising at least one wall upstanding from the platform; means for securing the animal's tether; and an elevated feeding reservoir integral to the apparatus.

In each of the aforementioned embodiments, it is envisioned that means for generating and forcing heated air through the air chamber comprises a hair dryer coupled to the air chamber, or alternately, a heating unit and a blowing unit mutually and operatively coupled, the heating unit and the blowing unit coupled to the air chamber generating and forcing heated air through the air chamber. The hairdryer, or the heating unit and blowing unit in combination, is/are coupled to the air chamber via a void formed in the at least one wall formed along the perimeter of the base and the platform.

In each of the aforementioned embodiments, it is envisioned that the reservoir may be placed at an appropriate feeding height for the particular animal. Therefore, the reservoir may be manually adjustable between a maximum height and a minimum height.

The use of the present invention allows for an animal such as a pet to be dried in a manner which is quick, easy, and efficient.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of an animal dryer apparatus;

FIG. 1A is a perspective view of an animal dryer apparatus shown having three upstanding walls;

FIG. 2 is an exploded perspective view of the platform, wall(s) and base;

FIG. 3 is a front view of the apparatus of FIG. 1;

FIG. 4 is a side view of the apparatus of FIG. 1, FIG. 2 and FIG. 3;

FIG. 5 is a top view of the platform of FIG. 2; and

FIG. 6 is a perspective view of an animal dryer apparatus shown having a pair of integral, elevated feeding reservoirs.

### DESCRIPTION OF THE PREFERRED EMBODIMENT

### 1. Detailed Description of the Figures

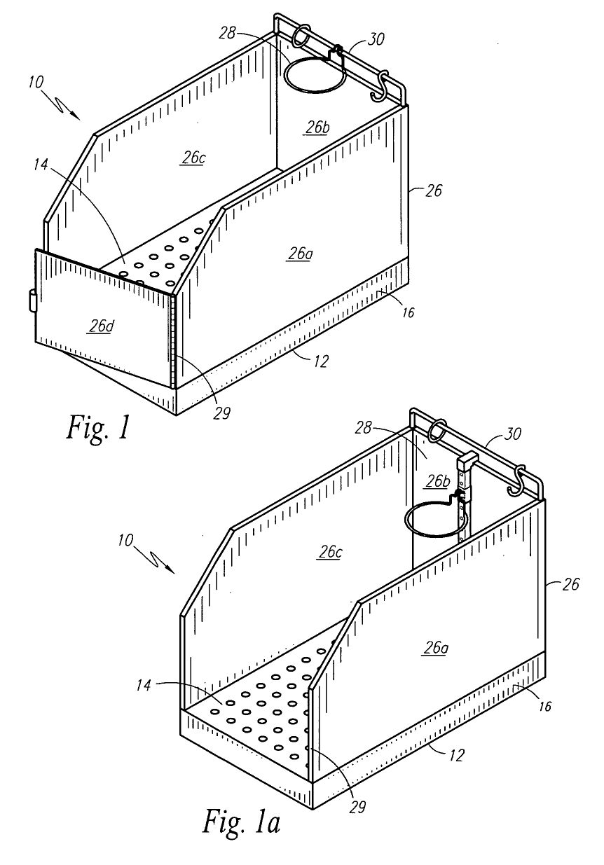

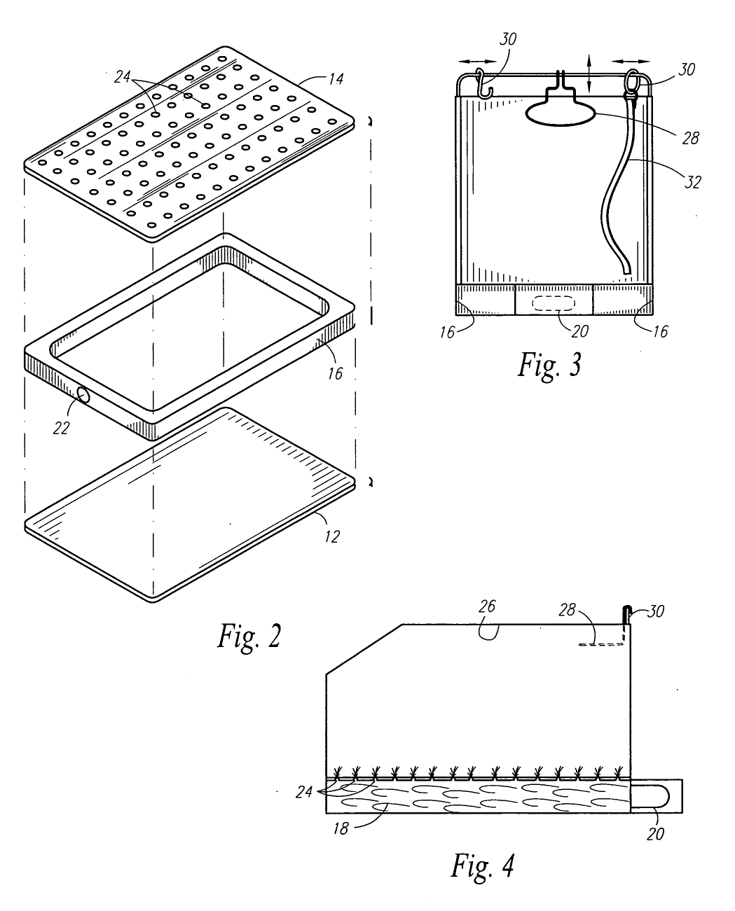

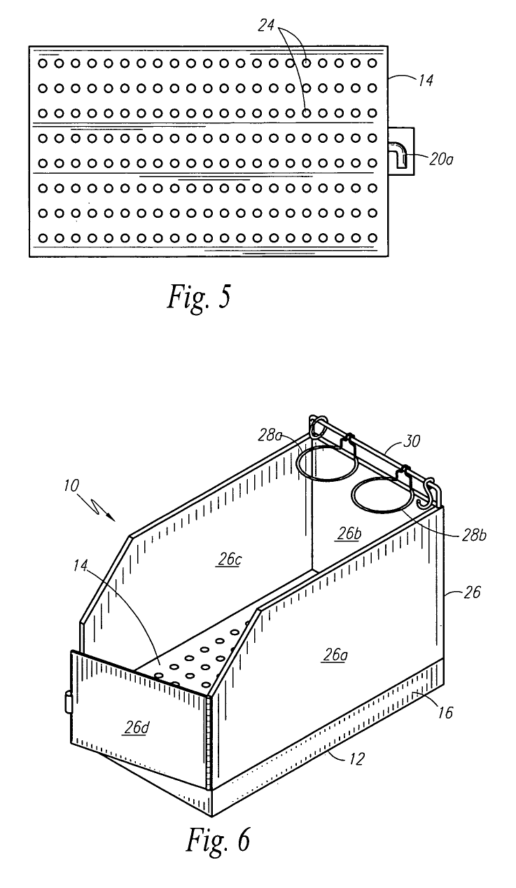

With reference to the figures, specifically FIG. 1 through FIG. 6, an improved animal dryer apparatus is disclosed and generally denoted by the reference character 10. Referring now to FIG. 1 through FIG. 5, one embodiment disclosed describes an animal dryer apparatus 10 comprising a base 12 positioned subjacent relative to a platform 14. At least one wall 16, and it is envisioned that a plurality of walls may be utilized, is formed along the perimeter of the base 12 and the platform 14, thereby enclosing and defining a space labeled as an air chamber 18. The wall(s) 16 are load-bearing and must provide the support necessary to prevent bowing, damage or collapse of the platform 14. The wall(s) 16 may be further supported by interconnecting or coupling the wall(s) 26 (described in more detail below) with wall(s) 16, providing an additional depth of support and rigidity to the enclosure, and the platform 14 and wall(s) 16 in particular.

A heating unit and a blowing unit 20, depicted as a hair dryer 20a as but one example of the devices envisioned, is coupled or interconnected with the air chamber 18 via a void 22 formed in the wall (or one of the walls) 16. When the units 20 (e.g. hair dryer 20a) is electrically activated and operable, heated air is generated and forced into the air chamber 18. The platform 14 comprises a plurality of apertures 24 that permits the heated air to flow through the air chamber 18 to the target animal (not shown) placed onto the platform 14 for drying. The heating unit and blowing unit 20 (e.g. hair dryer 20a) comprises an electrical cord for coupling or interconnection with an electrical outlet to provide a source of electricity to the unit(s) 20 for generating and discharging warm or heated air. A separate electrical switch may be mounted onto the apparatus 10 and electrically coupled or interconnected with the unit(s) 20. The unit(s) 20 may also have variable switches to moderate the quantity and intensity of the heat generated by the unit(s) 20 during operation. It is further envisioned that an automatic shut-off may be included, wherein the shut-off is electrically coupled or interconnected with the unit(s) 20 to terminate the drying phase after a predetermined or input period of time, or if the air temperature rises above a certain threshold. Other parameters may also be taken into consideration for actuating the shut-off characteristics provided, including temperature of the motor used in the unit(s) 20, among several other characteristics.

The apparatus 10 may further include an enclosure 26 that may have a variety of forms. In one envisioned embodiment, the enclosure 26 may comprise a single upstanding wall 26a upwardly depending from the platform 14. In another embodiment, the enclosure 26 may comprise a plurality of upstanding walls 26b, 26c, 26d, or the enclosure 26 may comprise a plurality of upstanding walls 26a, 26b, and 26c as shown in FIG. 1A (and is envisioned to include additional upstanding walls if necessary) upwardly depending from the platform 14. In one example (FIG. 1), the enclosure 26 may comprise four upstanding walls 26a, 26b, 26c, and 26d defining opposed side panels, a front panel and a rear panel, and wherein the rear panel is coupled to one of the side panels via a hinge 29, thereby functioning as a door to control ingress and egress of the animal therethrough.

The wall(s) 26 may be positioned to encourage concentrated distribution of the heated air fluidly communicated through the apertures 24 to the animal. The wall(s) 26 may also be positioned to inhibit the claustrophobic impact that the wall(s) 26 may have on an animal. It is envisioned that a plurality of walls may be provided that are manually adjustable to accommodate the various personalities of the animals that may be placed into the apparatus, whereby the walls may be enclosed more closely on one animal relative to another animal provided that the animal is comfortable with enclosed environments. Likewise, an animal less comfortable with an enclosed environment may feel more comfortable with the walls adjusted outwardly to provide the sense of minimally restricted movement.

It is further envisioned that the area above the top margin of the wall(s) of the enclosure 26 may include a removable top panel (if appropriate for the animal in question). It is envisioned that the apparatus 10 will generally be utilized without a removable top panel.

As warm or heated air is forced from the air chamber 18 and through the apertures 24 in fluid communication with the animal placed within the enclosure 26, it is envisioned that the fluid on the animal will evaporate, thus not requiring a separate pan or tray for collection of excess fluid that drains from the animal. However, it is envisioned that excess fluid may drain through the apertures 24 into the air chamber 18, with the fluid evaporating over time because of the warm or heated air that passes through the air chamber 18. Therefore, the apparatus 10 does not require a separate pan or tray that must be changed and/or cleaned to dispose of drainage of excess fluid.

The apparatus 10 may further include a feeding reservoir 28 to entice the animal into the enclosure 26 and to maintain the animal in that general position for the duration of the drying period. It is envisioned that the feeding reservoir 28 may be integral to the apparatus 10, and may be integral to the enclosure 26. It is further envisioned that the reservoir 28 may be adjustable in one or both of the vertical direction (FIG. 1a) and the horizontal direction (FIG. 1), which may be achieved by a number of devices and/or methods presently known and/or available. The vertical and/or horizontal adjustability of the reservoir 28 accommodates a variety of heights and/or sizes of animal that may require drying. It is well-accepted that the optimum feeding position for an animal is generally elevated above ground or floor level, and specifically is more closely aligned with the natural head position of the particular animal. The reservoir 28 may be exclusively used for food or treats, or exclusively for water. It is also envisioned that the reservoir 28 may have separate wells 28a and 28b (shown in FIG. 6), for example, for dedicated use of food and water in combination.

The apparatus 10 may further include means for tethering 30 the animal within the enclosure 26. Means for tethering 30 may include a number of apparatuses or devices, including the use of rings for accommodating clips or hooks (including carabiners, sliding J-clips, and other similar devices). Means for tethering 30 may also include a rod or cylinder that the tether 32 may be tied to. It is also envisioned that a separate proprietary tether having hook or loop material, clips, carabiners, or other similar devices might be coupled or interconnected with means 30 and that may be further coupled or interconnected with the collar of the animal. It is envisioned that the individual elements of the tethering means 30 may be adjustable vertically and/or horizontally to best accommodate the size of the animal and the positioning of other features and elements within the enclosure 26.

The materials for constructing or manufacturing the apparatus 10 may vary in accordance to cost and availability of material(s). It is envisioned that the material will be suitably durable for the intended use of the apparatus 10, therefore metal and plastic are generally considered appropriate, as well as materials possessing the same or similar characteristics. In particular, the material should withstand repeated ingress and egress of animals having claws, therefore marring of the surface is a consideration. The material should also withstand and maintain its general properties and characteristics during drying, therefore material that does not easily deform due to weight and/or heat from the dryer 20a or heating/blowing unit 20 combination is envisioned.

It is envisioned that the various embodiments, as separately disclosed, are interchangeable in various aspects, so that elements of one embodiment may be incorporated into one or more of the other embodiments, and that specific positioning of individual elements may necessitate other arrangements not specifically disclosed to accommodate performance requirements or spatial considerations.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

### 2. Operation of the Preferred Embodiment

To use the present invention, user actuates the heating and blowing unit 20. User then directs the animal onto the platform 14 in such a manner whereby the animal's head is oriented toward the feeding reservoir 28. User may opt to tether the animal to the tethering means 30 to maintain the animal in that general position for the duration of the drying period. After effectively drying the animal, user releases the animal from the tethering means 30 and powers off the heating and blowing unit 20.

The use of the present invention allows for an animal such as a pet to be dried in a manner which is quick, easy, and efficient.

Therefore, the foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be broadly limited only by the following Claims.

What is claimed is:

1. A dryer apparatus comprising:
an air chamber defined by a base subjacent to a platform, the air chamber enclosed by at least one wall formed along a perimeter of the base and the platform;
means for generating and forcing heated air through the air chamber;
the platform comprising a plurality of apertures through which the heated air is forced into fluid communication with an animal placed on the platform;
an enclosure comprising at least one wall upstanding from the platform; and
an elevated reservoir integral to the apparatus, the reservoir storing food or water.

2. The apparatus of claim 1 further comprising means for securing a tether.

3. The apparatus of claim 1, wherein means for generating and forcing heated air through the air chamber comprises a hair dryer coupled to the air chamber.

4. The apparatus of claim 3, wherein the hair dryer is coupled to the air chamber via a void formed in the at least one wall formed along the perimeter of the base and the platform.

5. The apparatus of claim 1, wherein means for generating and forcing heated air through the air chamber comprises a heating unit and a blowing unit mutually and operatively coupled, the heating unit and the blowing unit coupled to the air chamber generating and forcing heated air through the air chamber.

6. The apparatus of claim 6, wherein the heating unit and the blowing unit are coupled to the air chamber via a void formed in the at least one wall formed along the perimeter of the base and the platform.

7. The apparatus of claim 1, wherein the reservoir is positioned at an appropriate height for the particular animal.

8. The apparatus of claim 7, wherein the reservoir is manually adjustable between a maximum height and a minimum height.

9. An animal dryer apparatus comprising:
an air chamber defined by a base subjacent to a platform, the air chamber enclosed by at least one wall formed along the perimeter of the base and the platform;
means for generating heated air through the air chamber;
the platform comprising a plurality of apertures through which heated air is forced into fluid communication with an animal placed on the platform;
an enclosure comprising at least one wall upstanding from the platform;
means for securing an animal's tether; and
an at least one elevated feeding reservoir integral to the apparatus.

10. The apparatus of claim 9, wherein means for generating and forcing heated air through the air chamber comprises a hair dryer coupled to the air chamber.

11. The apparatus of claim 10, wherein the hair dryer is coupled to the air chamber via a void formed in the at least one wall formed along the perimeter of the base and the platform.

12. The apparatus of claim 9, wherein means for generating and forcing heated air through the air chamber comprises a heating unit and a blowing unit mutually and operatively coupled, the heating unit and the blowing unit coupled to the air chamber generating and forcing heated air through the air chamber.

13. The apparatus of claim 12, wherein the heating unit and the blowing unit are coupled to the air chamber via a void formed in the at least one wall formed along the perimeter of the base and the platform.

14. The apparatus of claim 9, wherein the at least one elevated feeding reservoir is positioned at an appropriate feeding height for the particular animal.

15. The apparatus of claim 14, wherein the at least one elevated feeding reservoir is manually adjustable between a maximum height and a minimum height.
